(19) United States
(12) Patent Application Publication
(10) Pub. No.: US 2008/0061212 A1
(43) Pub. Date: Mar. 13, 2008

(54) Tank Apparatus

(76) Inventors: Carl J. Conforti, Fall River, MA (US); Wayne Edward Shea, South Easton, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/764,414

(22) Filed: Jun. 18, 2007

Related U.S. Application Data
(60) Provisional application No. 60/825,473, filed on Sep. 13, 2006.

(51) Int. Cl. F16M 13/00

(52) U.S. Cl. 248/634; 248/560

(57) ABSTRACT

A tank apparatus for use with transporting cylindrical shaped containers comprising a main body sheet like material configured to attach to at least a portion of a tank's outer diameter and a pair of stops incorporated with the main body to prevent movement of the tank or container like object. Many features and variations of the apparatus are disclosed to provide added convenience and adapt to various fields of interest.

### CROSS-REFERENCE TO RELATED APPLICATIONS

This application claims benefit of U.S. Provisional Patent Application Ser. No. 60/825,473, filed Oct. 18, 2006, entitled Fuel Tank Apparatus.

### BACKGROUND OF THE INVENTION

1. Field of the Invention

The present invention relates in general to an apparatus to prevent a cylindrical storage container from moving while transported inside a vehicle. More particularly, the present invention relates to an apparatus that can be positioned around at least a portion of a cylindrical container to prevent undesired movement of the container or like objects.

2. Discussion of Related Art

Tanks and containers are commonly found in today's market having a variety of uses in both industrial and consumer applications. Often, storage tanks are transported inside a vehicle from one place to another. Most tanks by design are round, cylindrically shaped and often become unstable during transportation. Commercial vehicles are sometimes custom fitted with hardware or fasteners to securely mount tanks from moving while transported. Private vehicles, on the other hand, do not include any mechanisms for mounting tanks or preventing uncontrolled movements within the vehicle. Although most storage containers and tanks are designed with features to prevent the container from leaking, tanks rolling around in a moving vehicle creates a risk of impacting the inside fender, causing damage to the automobile body panel.

Many tanks, commonly filled with fuel, water, or other liquids, solids or gas materials and are refilled and reused frequently. There are millions of tanks sold and refilled each year in the United States alone. There are large numbers of vehicles unsafely transporting tanks with limited ability to prevent tanks from moving while transported. Storage containers and tanks often become dirty and can contaminate the interior of a vehicle and other areas they may contact during handling or transport. For example, gas-grill type propane tanks are frequently used for cooking food and may become greasy or dirty and contaminate surfaces they are in contact with during transport.

There are various types of hardware available that may be adapted to secure a tank to the inside of a vehicle. However, such hardware requires altering the vehicle body or drilling then fastening hardware to adapt to a vehicle. Many fasteners commonly found on the market can be customized to barricade a tank to a specific area within a vehicle during transport to prevent tanks from moving. Fasteners, straps and like members found on the market today are not readily available, adaptable or easy to assemble to prevent tanks from moving. Products such as tank stands, configured with hardware and other related components can be found fixed to a gas grill to securely fasten the tank to the frame. Some devices found on the market to are bulky and not easy to store taking up valuable space inside a vehicle in some cases require additional components that may not readily available for use when needed space. Limitations of space within the vehicle and permanent alteration of the vehicle body prove to be a disadvantage of current devices on the market today. They do not offer a method to prevent the tank from tipping, rolling nor an economical compact design to limit movement during transportation.

### SUMMARY OF THE INVENTION

It has been noted an advantage of the proposed invention provides a solution to effectively store, wrap and immobilize cylindrical containers during transport. According to one aspect of the invention, an apparatus includes a pair of stops which can be positioned on the outside diameter of the tank or cylindrical container to prevent movement. The stops are of sufficient size and positioned to contact the sides of the tank in order to prevent rolling. The mechanisms for creating, positioning and retaining the stops relate to various aspects of the invention.

In one aspect of the invention, the stops are formed on a substantially planar sheet of material. The sheet can be placed within the vehicle. The tank is positioned between the stops. According to another aspect of the invention, the stops are jointly formed with the sheet. According to another aspect of the invention, the stops are attachable to the sheet. According to another aspect of the invention, the positions of the stops are adjustable to accommodate different diameter tanks or containers or like objects. According to another aspect of the invention, the stops are configured with a fastener (i.e. hook like material) to further prevent unwanted movement.

According to another aspect of the invention, the stops are formed on a flexible sheet of material. The flexible sheet can be securely wrapped around the cylindrical tank. According to one aspect of the invention, the flexible sheet is secured around the tank by a fastening member. According to another aspect of the invention, the flexible sheet includes handles for carrying the tank. According to another aspect of the invention, the flexible sheet includes a frame for creating a U-shaped enclosure to hold the tank.

According to another aspect of the invention, the stops are jointly formed as part of the flexible sheet. According to another aspect of the invention, the stops are attached to the flexible sheet. According to another aspect of the invention, the stops are at least one pair, but can be a multiple plurality of stops configured to the flexible sheet of material.

According to another aspect of the invention, the flexible sheet has a width that substantially covers the outer diameter if the cylindrical tank. According to another aspect of the present invention, the stops are configured as a long narrow flexible strip of material that can be attached to the diameter of a cylindrical tank According to another aspect of the present invention, the stops may further be configured with a hook like material to grip a loop like material inside the vehicle and prevent movement of the tank. The outer surface of the tank is covered when the flexible sheet is positioned around the tank. According to another aspect of the invention, a protective sheet is positioned on the inner surface of the flexible sheet of material. The protective sheet contacts the outer surface of the tank. According to one aspect of the invention, the protective sheet may be waterproof. According to one aspect of the invention, the protective sheet may be washable. According to one aspect of the invention, the protective sheet may be disposable.

According to another aspect of the invention, the flexible sheet may be configured with a water resistant material. According to one aspect of the present invention the flexible sheet of material may be configured of a biodegradable material. These and other advantages of the invention, along with the invention itself will be more fully understood after review of the following figures, detailed description and claims.

### BRIEF DESCRIPTION OF THE DRAWINGS

FIG. 1 is a perspective, top view of a tank apparatus according to a first embodiment of the invention.

FIG. 2 is a side view of the tank apparatus of FIG. 1.

FIG. 3 is a perspective, bottom view of a tank apparatus according to a second embodiment of the invention.

FIG. 4 is a side view of the tank apparatus of FIG. 3 attached to a tank.

FIG. 5 is a perspective view of a tank apparatus according to a third embodiment of the invention.

FIG. 6 is a partial view of a handle for a tank apparatus according to an embodiment of the invention.

FIG. 7 is a top view of a tank apparatus according to an embodiment of the invention.

FIG. 8 is a bottom view of a tank apparatus according to a fourth embodiment of the invention.

FIGS. 9A and 9B are side views of the tank apparatus of FIG. 7 attached to a tank.

FIG. 10 is a perspective view of a tank apparatus according to a fifth embodiment of the invention.

FIG. 11 is a perspective view of a tank apparatus according to a sixth embodiment of the invention.

FIG. 12 is a perspective view of a tank apparatus according to a seventh embodiment of the invention.

FIG. 13 is a perspective view of the tank apparatus of FIG. 12 attached to the tank.

### DETAILED DESCRIPTION

The present invention operates to prevent movement of a cylindrical tank or like containers during transport. The apparatus includes a pair of stops which are configured to form a wedge like object on both sides of the tank to prevent tank movement. The stops are of substantial size, shape and positioned to prevent the tank from rolling and or moving. Various shaped stops are disclosed in various embodiments of the invention (i.e. round, triangular, hollow, collapsible). Also, different structures are used to position the stops in various embodiments of the invention.

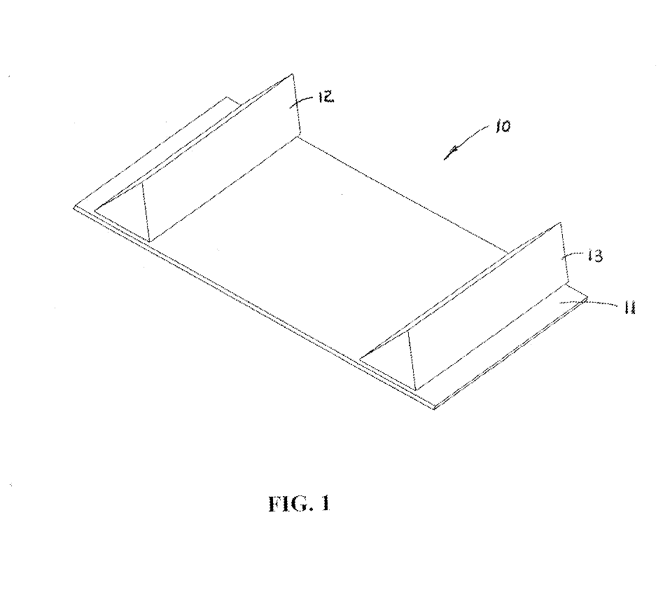

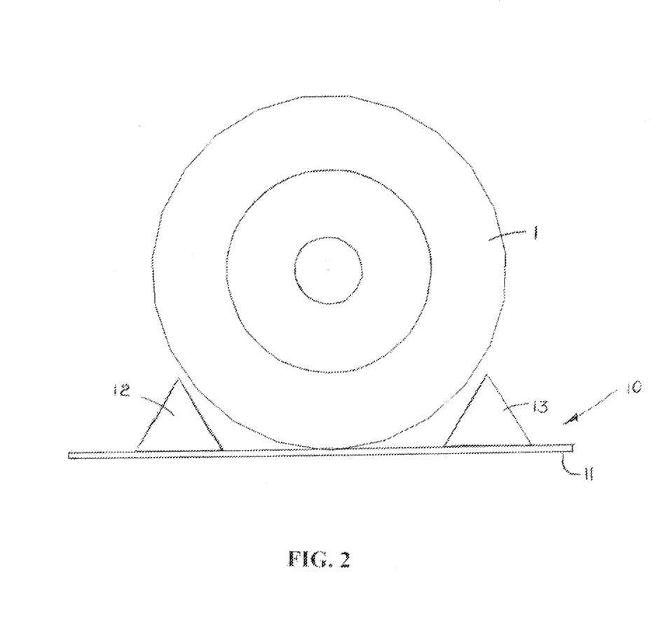

FIGS. 1 and 2 disclose a first embodiment of the invention. The structure of the tank apparatus 10 is shown in perspective view in FIG. 1. The tank apparatus of this embodiment includes a sheet 11 and at least two anti-roll stops 12, 13. The stops are of triangular shape and extend away from the sheet 11 to form a wedge preventing movement of the tank or like container. Although the stops are shown in triangular geometry, other stop geometric configurations can be utilized to prevent movement. FIG. 1 illustrates the sheet 11 extending beyond the stops 12, 13. However, the sheet 11 may be sized to end at the outer edges of the stops 12, 13. FIG. 2 illustrates the tank apparatus with a tank 1 positioned thereon. The stops 12, 13 are positioned on either side of the tank 1 in contact with the outer sides. The stops 12, 13 are preferably of triangular shape. Of course, other shapes, sizes and configurations could be used. The configuration of the stops may be adapted with various diameter tanks. The stops 12, 13 should be of sufficient size so that the tank 1 cannot roll over them during normal transport within the vehicle. For a standard 12″ diameter tank, a stop height of 1½-3″ is sufficient. Preferably, the stops 12, 13 are substantially the same length as the length of the tanks outer most diameter, or somewhat equivalent in size to prevent movement. However, they may be of any length sufficient to hold the tank 1. A larger or longer tank 1 may require larger and/or longer stops 12, 13. While the stops are shown as having planar sides as with a triangle, they may also be arced to mate with the surface of the tank 1. The stops may be fixedly attached, detachable, welded or fastened by other methods. The stops may be configured of plastic, foam, and board or other like materials. The stops may be hollow or solid for design or cost reasons.

The sheet 11 and stops 12, 13 may be of various materials and constructed using various techniques. They may be of the same material or of different materials. In one embodiment, the sheet 11 and stops 12, 13 are formed as a single unit of plastic material. According to another embodiment, the sheet 11 is formed separately from the stops. The sheet 11 may be of fabric, plastic, metal, polyester, non-woven polypropylene, PVC, rubber or other like materials. The sheet can also be formed of multiple materials joined together. Preferably, the back side of the sheet 11 is of a material which does not easily slide when placed on a substantially flat surface inside a vehicle. A high coefficient of friction material may be used for this purpose to prevent movement (i.e. rubber, elastomer, PVC, or like materials). Additionally, since many vehicles have carpeting (i.e. loop material) within the trunk or other areas inside the interior of the vehicle, a hook like material or hook fastener, can be attached to or part of the sheet 11. The hook like material or hook fastener can attach to the carpet of the transport vehicle to prevent movement of the sheet 11 within the vehicle. Magnetic materials or components may also be used in a similar method or construction within the sheet, having the ability to attach to various body panels of the vehicle.

The stops 12, 13 may be formed of paper, plastic, polyethylene foam, wood, metal, cardboard, etc. They may be formed as a single solid part, a hollow part or configured to form a shape to prevent movement (i.e. triangle, circle, wedge, or other anti-roll shape). They may be a single material or created from multiple materials, and may be weather resistant or biodegradable, recyclable, or environmentally friendly materials. All of the sides of the triangle need not be part of the stops 12, 13. In one embodiment, the stops 12, 13 may include one side facing the tank and triangular or other shaped supports to properly position the side configured to be in a close proximity of the tanks outer diameter. A cylinder of material may be formed with the sheet 11 to hold the stops 12, 13 in position. Alternatively, the stops 12, 13 may be attached to the sheet 11 with adhesives, welded, fasteners, permanent or temporary fastening methods. Additionally, the stops 12, 13 may be removably attached to the sheet 11. For example, hook and loop fasteners may be used on the stops 12, 13 and sheet 11. This would allow the distance between the stops 12, 13 to be adjusted to accommodate different sized tanks.

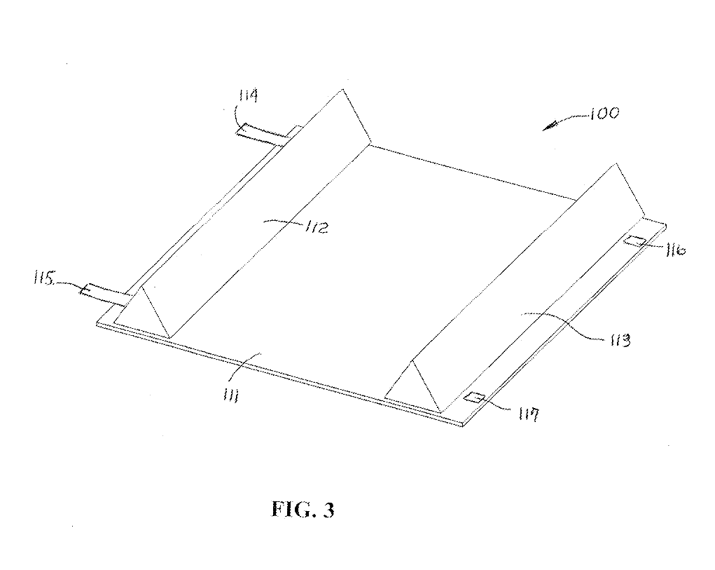

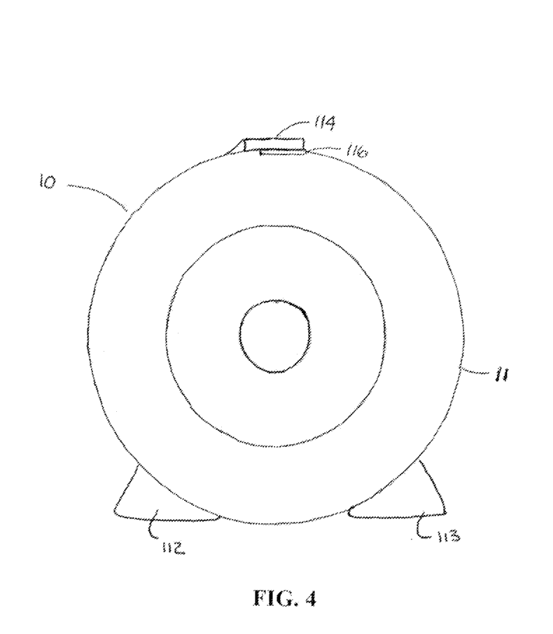

Another embodiment of a tank apparatus 100 of the present invention is illustrated in FIGS. 3 and 4. This embodiment also includes a thin sheet of flexible material 111 and two stops 112, 113. In the first embodiment discussed above, the sheet 111 is planar, configured as a mat to be placed in the trunk or floor of a vehicle for transport. In the second embodiment, the sheet 111 is sized to adapt to the diameter of tank 1. The outer surface of the apparatus device 10 of FIG. 1 is placed towards the tank 1 in one configuration. On the other hand, the upper surface of the apparatus device 100 of FIG. 4 is place away from the tank 1 in yet another configuration where the stops are positioned to prevent the tank from moving and the apparatus is attached to the tank. The apparatus is configured with at least one fastening device. For illustration, a pair of fasteners 114, 115 extends from one end of the sheet 111. A second mating pair of fasteners 116, 117 is positioned on the other end of the sheet 111. The first pair of fasteners 114, 115 and the second pair of fasteners 116, 117 are configured to hold the sheet 111 in place around the tank 1. They may include hook and loop fasteners, elastic, snaps, magnetic closures, ties, or other fastening devices. The fastener may further be configured to adjust and adapt to various diameter tanks. While the embodiment illustrated in FIGS. 3 and 4 show the fasteners 114, 115 extending from the sheet 111, they may be formed as part of the edge of the sheet. Alternatively, the entire edge of the sheet 111 may be used as a fastener or further configured to be made of a loop material, and have at least one hook fastener securely fastened to one end to secure the tank or like container within the apparatus. The hook material can be configured to a portion of the apparatus, or selectively attached to prevent movement of the tank or container.

In use, the apparatus 100 of this embodiment is wrapped around a tank 1 and secured using the fasteners 114, 115, 116, 117. Preferably, the sheet 111 has a length which corresponds with the circumference of the tank 1 or at least a portion of the tanks circumference that may come in contact with the vehicles interior. The stops 112, 113 are attached to the outer surface of the sheet 111. They are positioned such that they contact a point on the vehicles interior's surface one side of the tank 1 to prevent rolling. In addition, the stops are located opposite of one a point of the tanks' diameter point of contact on the vehicle's interior surface. The stops 112,113 in one embodiment can be constructed of a hook material on at least one side to further prevent two or three dimensional movement of the apparatus and tank within the vehicles.

As with the first embodiment, the sheet 111 and stops 112, 113 may be formed of various materials and construction methods. The stops 112, 113 may be fixed in position or adjustable to accommodate different diameter tanks. The outer surface of the sheet 111 and/or stops 112 may include a material or structure, such as fabric, rubber, or plastic magnetic or hook fasteners, which operates to prevent movement of the tank apparatus 100 within the vehicle. When not in use, the anti-roll apparatus 100 can be easily rolled or folded to minimize the space required for storage.

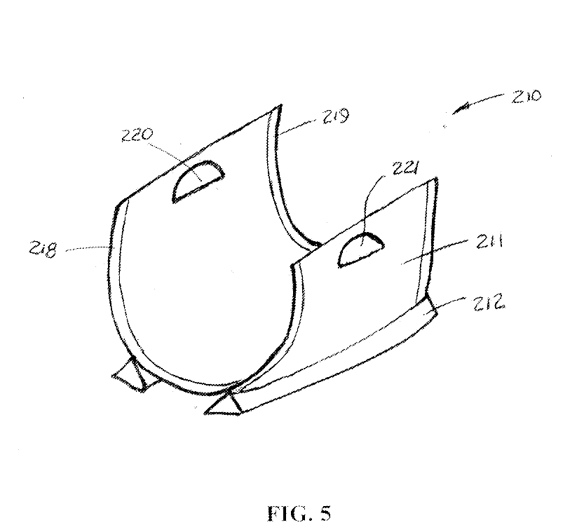

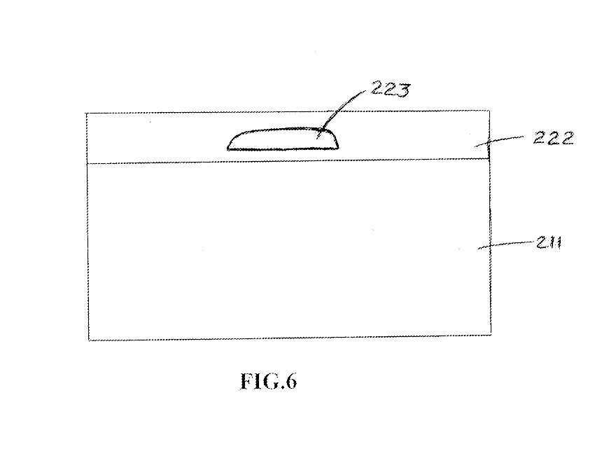

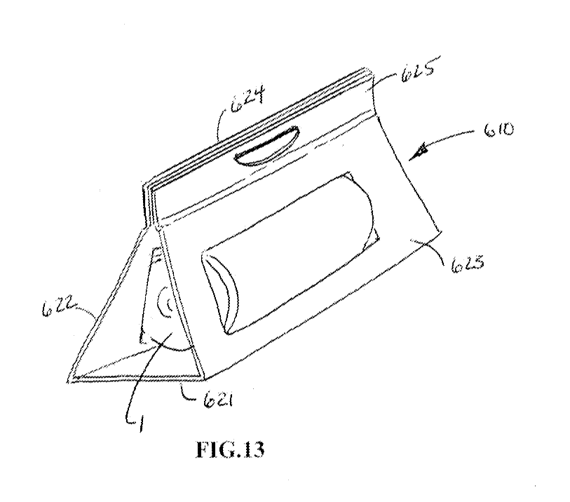

FIG. 5 illustrates another embodiment of the tank apparatus 210 of the present invention. As in the prior embodiments, this embodiment includes a resilient body 211 and stops 212, 213. In the prior embodiment, the sheet 111 was flexible and wrapped around the tank. In this embodiment, the resilient body 211 includes a spring-like material 218, 219 at least along the edges. The spring-like material forms a “C” shape of a size similar to the periphery of a tank. The edges of the resilient body 211 are moved apart to insert the tank within the tank apparatus 210. When released, the spring-like material forces the resilient body 211 around the tank to hold it in place. As in the prior embodiments, the stops 212, 213 are attached to the resilient body 211 at positions to prevent rolling of the tank. The stops 212, 213 may be permanent, adjustable or removably attached. As with the second embodiment, a fastener (not shown) may be used at the edges of the resilient body 211 to securely fasten the tank apparatus to the tank. The edges may be configured with a high coefficient of frictional material to prevent movement from the tank to the apparatus and from the apparatus to the vehicle interior. Handles 220, 221 may also be formed in the resilient body 211 to make carrying the tank easier, although handles are shown, one handle may be configured to the apparatus. Depending upon the materials used for the resilient body 211, the handles 220, 221 may be merely holes formed in the resilient body. Alternatively, as illustrated in FIG. 6, a separate handle 222 may be formed along the edge of the resilient body 211. The handle 222 has a separate handhold 223 to allow for easy gripping. The handles on each side of the resilient body 211 may be positioned to allow them to be held with one hand or two hands for carrying the tank. Further illustrated in FIG. 13, handles may be formed in the material to provide consumers a place to grasp the apparatus.

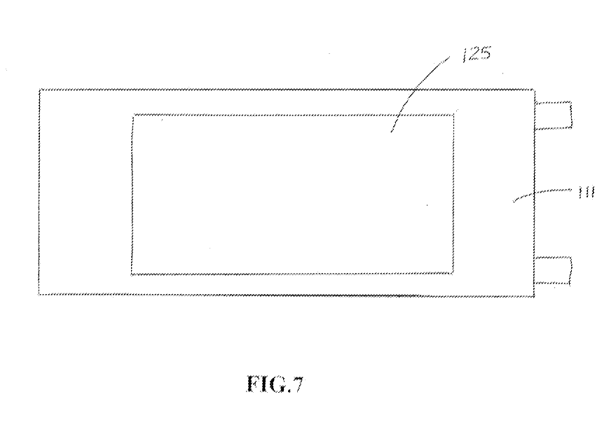

Tanks can become extremely dirty. Propane tanks used with barbeque grills often are greasy. The tank apparatus of the present invention provides a cover for the tank of like containers to prevent the dirt or grease from soiling the interior of the vehicle. Preferably, the tank apparatus is of a material which is easily cleaned. Additionally, as illustrated in FIG. 7, inserts 125 may be used on an interior surface of the sheet 111 of any embodiment of the invention. The inserts 125 may be held in place by various fasteners or mechanisms (i.e. hook and loop, adhesives, clips) with the sheet 111. The inserts 125 may be of a material which is disposable or environmentally friendly such as non-woven PP, hydrosun fibers, recycled paper or other like materials. The inserts can further be configured as removable to allow the apparatus and/or the inserts to be washable. Alternatively, the inserts 125 may be of paper, resin, plastic film or other material which is printed with advertisements or other like media. In one embodiment, the insert 125 may include a multiple layer of disposable liners to keep the tank clean between refueling, or have the ability to be removable to clean other related objects to the articles. The liners may also be sealed inside a container or plastic like bag with a liquid cleaner to allow cleaning of the tank, vehicle or other items with the liners. The liners may be a linear low density olefin polyethylene or disposable liners of EPM, UPM, or a combination of paper and other man made materials. The liners may further include printed matter such as instructions for use.

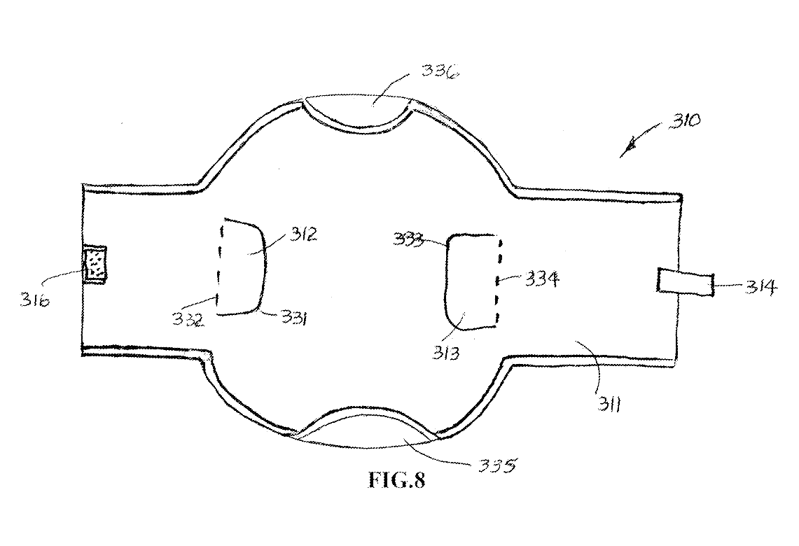

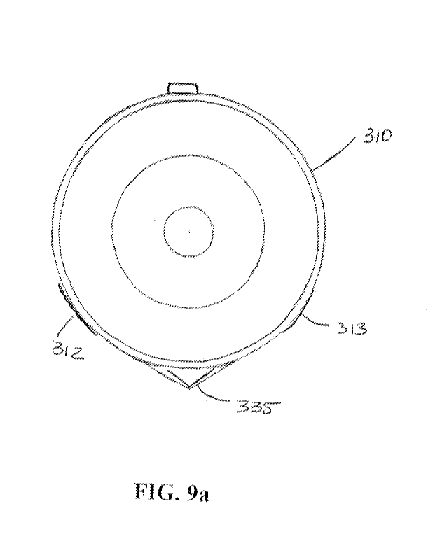

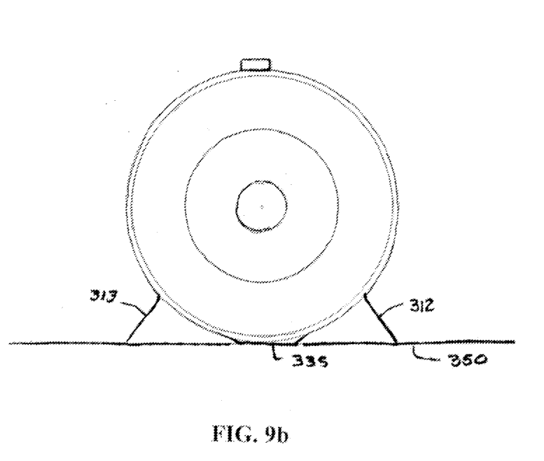

FIG. 8 illustrates another embodiment of the tank apparatus 310 of the present invention. This embodiment includes a sheet 311 of a stiffer material than the prior embodiments. As in the prior embodiments, it includes a fastener 314, 316 to hold the sheet 311 around a tank. It does not include separate stops attached to the sheet 311. Instead, the stops 312, 313 are formed as part of the sheet 311. Geometrically shaped slits of “C” shaped in this configuration 331, 333 are formed at locations on the sheet 311. When the sheet 311 is wrapped around a tank, as illustrated in FIGS. 9A and 9B, the stops 312, 313 within the slits 331, 333 are forced outward along lines 332, 334. The edges of the stops 312, 313 contact the surface 350 of the vehicle at an angle to prevent movement or rolling of the tank or like container. The apparatus can also be secured by a strap, cord or other fastener through the openings or body of the apparatus to secure the tank during transport.

In order to enable the stops 312, 313 to open properly, a spring-like stiffener material is configured along the edges 335, 336 of the sheet 311. The spring-like stiffener material is configured to hold the shape when the sheet 311 is wrapped around the tank as illustrated in FIG. 9A. When the tank is placed on the surface 350, the stiffener material enables stops 312,313 to move outwardly, and the stops 312, 313 when opened in position and prevents the tank from moving. The stops 312, 313 can fit into a channel or mating component to securely hold the tank, apparatus in place during transport.

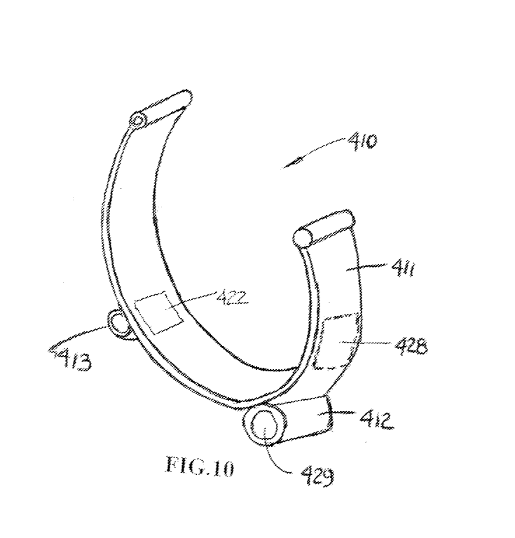

In the prior embodiments, the tank apparatus substantially covers the tank. This helps to keep the vehicle clean. However, other sizes of devices may be used which are more easily stored and may be more economical to produce. FIG. 10 illustrates a tank apparatus 410 formed for a C-shaped resilient, spring like material. Preferably, it is molded or formed of a plastic or metal and generally retains its shape. Other embodiments may include other materials or a combination of two or more materials. The stops 412, 413 are formed as extensions from the main body 411. They can be formed in a single molding process, or separate components attached to the main body, movable to adjust to various sizes and positions of the device or tank held by the apparatus. As illustrated in FIG. 10, in one configuration the stop or preferably a protrusion stops 412, 413. In configuration stop 413 may be formed as opening 422 within the main body of the apparatus. When the tank apparatus is formed, the stops 412, 413 are configured at angles to keep a tank from moving. The stops 412, 413 may further be configured with a through hole 429 to use as a receptacle for fastening to a rigid body or structure. The tank apparatus 410 of this embodiment may be narrow and only cover a portion of the tank. As with other embodiments, various materials, such as rubber or hook fasteners, can be attached to the tank apparatus 410 to prevent movement within the vehicle. The tank apparatus 410 may be configured to hold a tank or cylinder inside the “C” shape and also be configured as an option to include a fastener or clip (i.e. hook material, spring, clip or like fastener) 428 configured to within the body of the apparatus to attach an object on the outer diameter, or attach the apparatus to a vehicle's body. The geometry can be configured to stop a tank from moving, or hold an accessory, or mount vertically to a vehicle with a mounting loop components cord or strap during transport.

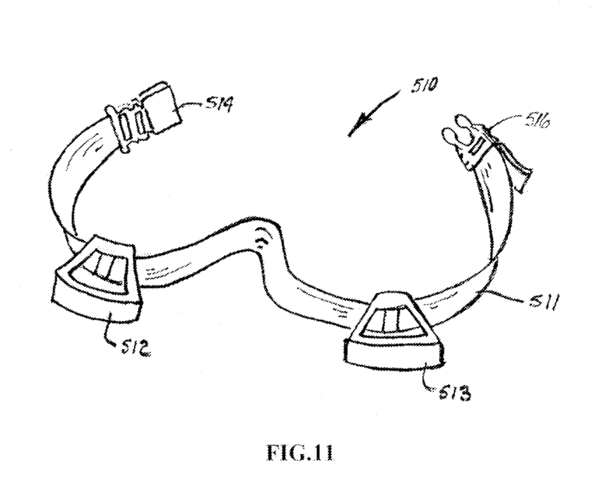

FIG. 11 illustrates another embodiment of the tank apparatus 510 of present invention. A strap like material 511 takes the place of the sheet. A tab 514 and connector 516 are positioned at the ends of the strap like material 511 to securely fasten the apparatus around the tank. Two stops 512, 513 are attached to the strap like material 511. The strap like material 511 is wrapped around the tank. The stops 512, 513 are then positioned to prevent the tank from rolling. As with the other embodiments, the stops 512, 513 may be fixed to the strap like material 511 or may be adjustably positioned to accommodate different sized tanks. The tab 514 and connectors 516 can be configured to adjust to various size tanks.

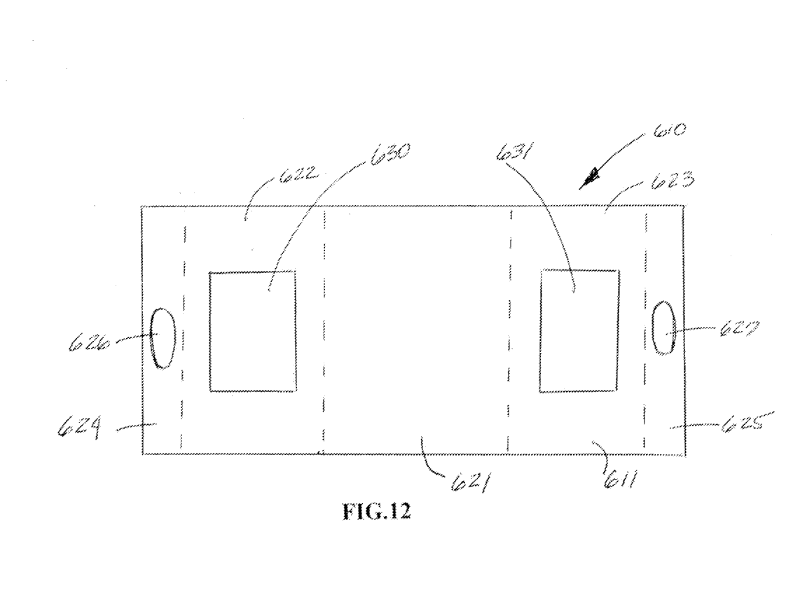

Another embodiment 610 of the invention is illustrated in FIGS. 12-13. This embodiment includes three panels 621, 622, 623 of a board like material. Paper, plastic or like materials may be used. More specifically, fluted cardboard or plastic may be used and folded along the fluted direction. The center panel 621 is a solid flat plane. The panels 622, 623 on either side have a cutout 630, 631. A handle panel 624, 625 extend from each of the end panels. A hole 626, 627 is formed in each handle panel 624, 625. The panels are configured to be formed, cut and folded to a compact shape. Hinges may be used, or the sheet 611 may be formed to allow bending between panels. The handle formed by holes 626, 627 are temporarily locked together to secure the tank in place on the apparatus. The flat surface 621 is configured to contact a flat surface inside a vehicle to further prevent movement of the tanks. The panels 621, 622, 623 can be printed with instructions or other media as desired by the manufacturers.

Use of this embodiment is illustrated in FIG. 13. The tank 1 is placed on the center panel 621. The two end panels are then bent towards the tank. The sides of tank extend through the rectangular cutouts 630, 631. The two handle panels 624, 625 are brought together. Preferably, the handle panels 624, 625 are connected together to hold the device in place. The handle panels 624, 625 allow for easy carrying of the tank. The center panel 621 provides a flat surface for the tank 1. The end panels 622, 623 hold the tank in place and prevent rolling. An optional hook material may be configured to the bottom side of the center panel to prevent movement.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A tank apparatus for use in vehicles to prevent movement of a tank, the tank apparatus comprising:
a resilient sheet having a length and width to cover at least a portion of a tank's outer diameter; and
a pair of stops attached to the sheet configured to a height and positioned on the sheet to form a wedge between opposing sides of a lower surface of the tank in contact with a vehicle surface on which the tank rests.

2. The tank apparatus according to claim 1, wherein the sheet and pair of stops are molded as a single unit.

3. The tank apparatus according to claim 1, wherein the pair of stops are releasably attached to the sheet.

4. The tank apparatus according to claim 1 further comprising a fastener attached to the sheet at one end having the ability to securely hold the sheet around the tank.

5. The tank apparatus according to claim 4, further wherein the fastener is adjustable to accommodate various tank sizes.

6. The tank apparatus according to claim 4, wherein the sheet is sized to substantially cover the outer diameter of the tank to keep the vehicle interior clean.

7. The tank apparatus according to claim 4, further comprising at least one handle on at least one end of the sheet.

8. The tank apparatus according to claim 1, further comprising a hook like material on a lower surface to grip a loop like mating material.

9. The tank apparatus according to claim 1, wherein the sheet further includes a resilient spring like member to hold the sheet in a C-shape.

10. The tank apparatus according to claim 1, wherein the stops are formed as part of the sheet.

11. The tank apparatus according to claim 10, wherein the stops are adjustable in position on the sheet.

12. The tank apparatus according to claim 1, wherein the sheet is foldable; and
wherein the tank apparatus further comprises: a fastener holding the sheet in a folded position for easy storage.

13. A tank apparatus for transporting a tank comprising:
a main body panel comprising a substantially flat sheet having the capacity to wrap around a cylindrical container;
a first end main body panel hingedly connected along a first edge of the center main body panel, the first end panel having a hole formed therein; and
a second end main body panel hingedly connected along a second edge of the center main body panel opposite the first edge, the second end panel having a hole formed therein, wherein the panels fold to form a three dimensional structure and the center main body panel is configured with a stop to prevent the container from moving during transport within a vehicle.

14. The tank apparatus according to claim 13, further comprising:
a first handle panel, having an handle formed therein, hingedly connected along an edge of the first end panel opposite the first edge of the center panel; and
a second handle panel, having a handle formed therein, hingedly connected along the edge of the second end panel opposite the second edge of the center panel.

15. The tank apparatus of claim 13 wherein the sheet includes a biodegradable material.

16. The tank apparatus of claim 13 further comprising a fastener for holding the panels in the three dimensional structure.

17. A container apparatus to prevent movement of a cylindrically shaped object during transport comprising;
a main body configured to wrap around the cylindrically shaped object;
a stop mechanism connected to the main body to contact a surface of the cylindrically shaped object to prevent rolling during transport; and
a fastening mechanism attached to the main body to securely wrap the apparatus around the cylindrical shaped object.

18. The container apparatus of claim 17, having a main body material comprising of a high coefficient rubber like material to prevent movement.

19. The container apparatus of claim 17, having a second fastener attached to the main body comprising a hook material for securing the container to a loop material to prevent movement.
